(19) United States
(12) Patent Application Publication
(10) Pub. No.: US 2016/0228325 A1
(43) Pub. Date: Aug. 11, 2016

(54) Motorized Muscle Relaxing Therapy System

(71) Applicants: Kevin G. Kologrivov, Garfield, NJ (US); Kumud Majumder, Upper Saddle River, NJ (US)

(72) Inventors: Kevin G. Kologrivov, Garfield, NJ (US); Kumud Majumder, Upper Saddle River, NJ (US)

(21) Appl. No.: 14/616,697

(22) Filed: Feb. 7, 2015

(51) Int. Cl. A61H 23/04; A61H 23/00

(52) U.S. Cl. CPC A61H 23/04; A61H 23/00

(57) ABSTRACT

A portable, flexible, versatile athletic massage device with improved adjustable therapeutic massage is described. It is comprised of one or more vibrating units embedded in a pliant wrap-around material. The wrap may be optionally pneumatically inflated, deflated, heated, cooled to adjust comfort level and snugness of the device. The vibrating head(s) provide pulsating massage that is manually or programmatically adjustable. The wrap may additionally contain one or many electro-stimulation devices/electrodes for providing localized muscle stimulation. These device is controlled using electronic controller(s) powered by electrical, battery or known power sources. The controller is operated manually or through preset programs, remote controls and/or through voice control. The wrap provides comfortable intimate contact with the body facilitating better relief of the injury/pain. Individual customization of massage of the target area is possible through user variable power supply and user variable placement of vibrating heads and electro-stimulators in the wrap.

### BACKGROUND OF THE INVENTION

1. Field of the Invention

This invention relates generally to a self-help Health Care devices methods and system. More particularly it relates to non-obvious therapeutic massage system for relieving or reducing muscle spasms and concomitant pain through muscle stimulation and relaxation through multipoint vibrating massage system supplemented by heating and/or cooling.

This invention also relates to using the combination therapy of muscle relaxation through massage and improved blood circulation through controlled local electric stimulation of muscle.

While benefits of using electrical stimulation of muscle for pain management is well established, this invention enhances such benefits by allowing easy combination of two well established processes of non-drug induced pain management. Specifically the modular design of this invention allows easy customization by the user as the user can easily adjust the intensity and frequency of the massage thereby improving its efficacy. Because this invention provides pain relief without the use of topically or systemically applied drugs, this invention can generally help in avoiding or reducing the use of habit forming pain killer drugs. In other words this invention can be used as a long-term pain relief solution without running the risk of any pain killer drug addiction.

Additionally, this invention relates to a portable massage system that can help reduce medical treatment cost by minimizing trips to the doctor's office for pain management. For certain types of joint injuries like knee injury, this invention can help in avoiding surgical procedures like relieving quadriceps tension.

2. Description of Prior Art

The problem with prior art therapeutic massage systems, devices and procedures is that they are either not easy to use or they become hard to use and essentially ineffective if the user plans to remain engaged in normal daily activities during the period when they are using these units. This is because many or most of the prior art systems are in fact designed for use in immobilized seating or lying down position.

Another type prior art device relevant to this invention are the systems that provide mild electrical stimulus to the targeted injury area to improve the blood flow thereby accelerating the pace of healing.

The US patent application 20050187497A1 discloses an electrical impulse apparatus for facial massage. The disclosed apparatus consists of microprocessor controlling an impulse generator to generate pulsed signals to two electrodes on a pad. The pad is attached to the facial skin. Switch buttons provide for activation of the pulse generation and verification of the strength of the pulses. Electro-muscle stimulation can be applied to facial muscles, by means of the disclosed device, and thereby the tonus of facial muscles and the blood circulation in the surrounding area may be increased. This device does not

A prior art device by Hammacher Schlemmer (2014) is designed to provide a mix of vibrating massage and electrical pulses. It provides heat through infrared radiation with no option for cooling. The device is designed as a neck collar and cumbersome. The position of the massage unit vis-à-vis electric pulsing units is preconfigured thus providing no opportunity for personalizing of the device to give maximum benefit to the patient. Notably, personalization of medical device is extremely important and is the latest trend in medicine.

A Canadian patent application- CA 2625707 C (Prizant, 2011) describes a sticky bandage (SB) attachable to a skin of a user. The SB comprising: a base having a proximal face and a distal face; a depression, accommodated to enclose at least one active substance, the depression located at the proximal face; a protecting cover, attached to the proximal face, wherein a rim of the proximal face is sticky; a vibrating member comprising at least two arrays of solenoids embedded in the SB base activated by means of an operating switch disposed in association with the distal face; and an electrically operated safety circuit for preventing activation of the vibrating member by the operating switch. This sticky bandage is not customizable by user. Nor is this device capable of providing gradient or local variation in massage intensity when using a single piece of the bandage.

Some of the prior art devices are quite complex and might even require FDA approvals due to very nature of their design and possible side effects on the human body.

A serious limitation of all prior art devices is that none of these devices is designed as a single unit that can provide a combination of massage and electrical stimulation in a customized fashion as often needed in patients who benefits from a combination of both treatment procedures. A case in point is the patients experiencing loss of bone in the mid-lateral facet of the kneecap. In these cases best treatment results are obtained when using a contrast therapy whereby one side of the kneecap receives relaxation of muscles through localized massage and the other side receives muscle tightening. More importantly, it is necessary to be able to customize this contrast therapy since the injuries received by individual patients are never identical. Another important advantage of the current invention is customized placement of massager and stimulator to get optimal benefit. Because of the modular nature of the unit, users can create a massage gradient or localized variation in massage intensity.

For the sake of discussion of what the prior art allows, one could possibly argue that hypothetically a prior art electronic muscle stimulator can be used in conjunction with a prior art muscle massager to get the combinatorial effect of alternative stimulation and vibratory massage. Albeit, in reality, this would require synchronizing the functions of two disparate systems with completely different controller units, making it extremely hard, if not impossible for a common man to benefit from such a combination. Moreover, side by side simultaneous placement of two different units from two different manufacturers, on a relatively smaller area like knee is highly challenging if not impossible. Stated simply, no prior art single unit provides for the combinatorial power and benefits of vibratory massage and electric muscle stimulation in the same way the current invention does.

Further more, none of the prior art massage or electric stimulation devices provide the degree of user control and variation that is an integral part of the current invention. Another advantage of the current invention is device customization to accommodate the differing requirements arising out of the injury type and body size of the patients. This is also very unique to the current invention.

The current invention addresses all these gaps in the current state of art thereby making it totally unique and having not even a very distant similarity to any existing device or invention.

### SUMMARY OF THE INVENTION

An object of the invention is to provide a multi functional electrical massager having features and advanced options not currently available in any of the available units.

An object of this invention is to also provide a multi-functional massager device that allows personalization of the system by convenient changing of the placement of the massage heads on the wrap-around unit. Through a unique modular design and selective programming ability of the controlling software, individual strips of magnetic heads can be applied different degree of power. This allows localized variation in the massage intensity, as no two injuries are alike and customization of massage based on the injury type allows faster relief of pain. Using any desired combination of the massage strips and the electro-stimulator strips on the massage device of this invention can be further customized. A tertiary level of customization can be obtained by applying gradient or differing electrical power to the individual strips. This ability to provide localized variation in a single massaging device is a very unique feature of the current design, as all other available systems operate under the all or nothing principle, meaning that variation of massage intensity within a single unit is not feasible for other units. When electrical stimulus is applied to prior art devices, the same stimulus is applied to the whole unit. In contrast our device is designed to generate local variation, if so desired by the user.

This invention also provides a means to the users to use a self-programmable electrical massage-stimulator combine that is not otherwise available. This together with the ability to adjust positions of the massager and electrodes (for electric stimulation of muscles) makes the present invention a truly personalized medical device.

This invention is particularly helpful for patients experiencing loss of bone in the mid-lateral facet of the knee cap, may be able to make use of the controlling system of the wrap to relieve tension on the left (or right) quadriceps muscles and focusing the motors vibrant activity on either-depending on which side of the knee has experienced bone loss. Currently, the only known treatments for relieving quadriceps tension, is for an Orthopedic surgeon to perform a procedure to physically cut the quadriceps muscle on the same side of the knee cap with the cartilage loss. The other known treatment, involves physical therapy to build up the quadriceps muscle to the opposite side of the portion of the knee cap experiencing the mid-lateral facet bone loss in order to relieve tension on to promote healing and cartilage regeneration. The treatment proposed here simulates the second treatment approach.

The current invention leverages the motor vibrations to reduce muscle tensions. This is exemplified by the quadriceps tension on the damaged side of the knee thus substituting the current massage for the surgical procedure for a “quadriceps release” by surgery of the quadriceps.

The wrap around component of the current invention uses materials that can act like a hook-and-loop, sticky or any suitable alternative fastener. In the loop and hook fastener embodiment, the wrap around is consisted of fabric with loops. The other portion that has the hooks bears the vibration heads and/or electrodes for electric stimulation. In another embodiment, the wrap around contains the hooks and the strip with vibratory motors has the loops needed for hook-and-loop fastening. This design allows customization of the massage by varying the placement of the vibratory heads in a patient and injury specific manner.

In another embodiment, the healing process is accelerated by providing customized vibration on the one side of the injured area and/or joint while the other side receives mild electrical stimulation to tighten the muscles. In this embodiment the vibrating motors of the present invention provides the relaxation, while the electrical stimulations is provided by making use of any of the commonly known technologies.

In a different embodiment, providing an alternating accelerates the injury healing process or other possible combinations of customized vibration based massaging and electrical stimulation of the muscle in the same general target area. In this embodiment the vibrating motors of the present invention provides the relaxation, while the electrical stimulations is provided by making use of any of the prior art technologies.

The current invention uses single strips with vibrating motors, these can be attached easily to any portion of the wrap around bandages making these customizable to different body parts of users of different weights and body types. Use. of pad units that can taped to the body makes it also easier to use the current inventions in large surface area body parts like chest, back, and so on.

The current invention is designed to make use of suitable battery or electrical power, the built in timing logic could be set to run continuously or with and on again—off again cycle such that it will be possible to provide customized therapy for extended period of time.

In essence, this invention gives an opportunity to the users to avoid multiple trips to the clinic and undertake muscle relaxation therapy at any time and place.

### BRIEF DESCRIPTION OF THE DRAWINGS

FIG. 1. A schematic diagram of a wrap around bandage like strip that is used for attaching strips containing vibrating motors and electric stimulation pads. The fasteners to maintain the wrap around in place are not shown.

FIG. 2. A schematic diagram of a single strip showing vibrating motors and connectors to be attached to the controller unit.

FIG. 3. A schematic diagram of a single strip showing conducting electrodes commonly used for human therapy. The electrodes are connected to the connectors that can be attached to the controller unit.

FIG. 4. A schematic diagram of a controller unit that allows programming of the vibrating motors and the electric stimulation pads.

### DETAILED DESCRIPTION OF THE INVENTION

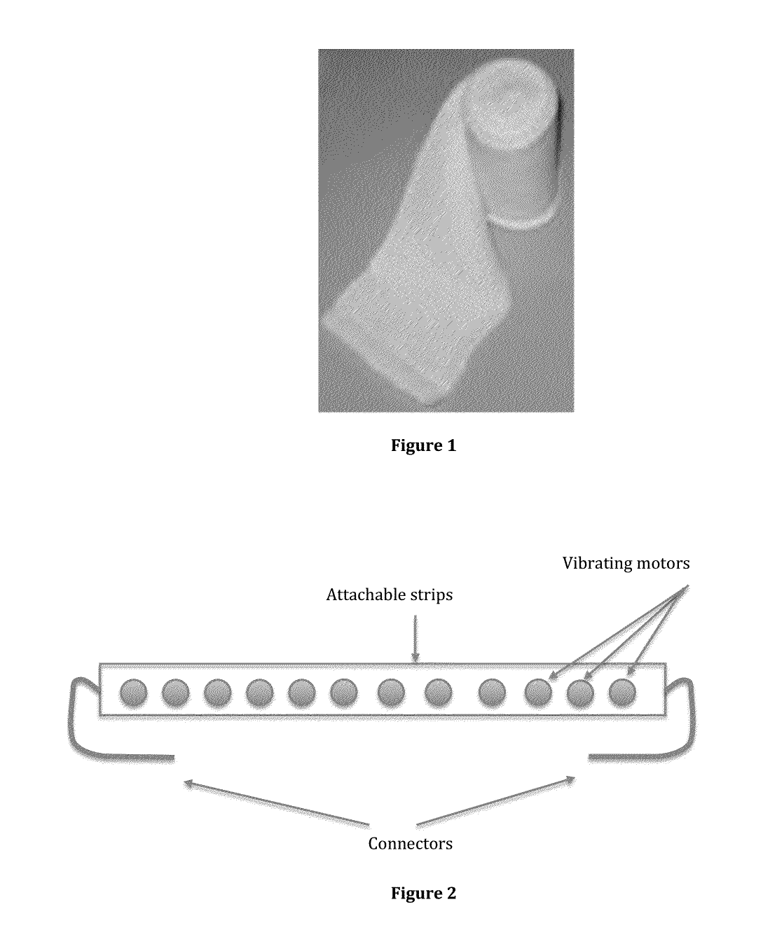

FIG. 1 shows a schematic diagram of a wrap around bandage like strip that is used for attaching strips containing vibrating motors and electric stimulation electrodes. The fasteners to maintain the wrap around in place are not shown.

FIG. 2 shows a schematic representation of a strip containing vibrating heads that are mounted on the strip such that a single strip or an array of strips can be attached to the body of the wrap around body of the massager. The electrical lead connectors are also shown at the two ends of the strip. For ease of display, only a single strip os vibrating heads with one set of connectors is depicted in FIG. 2.

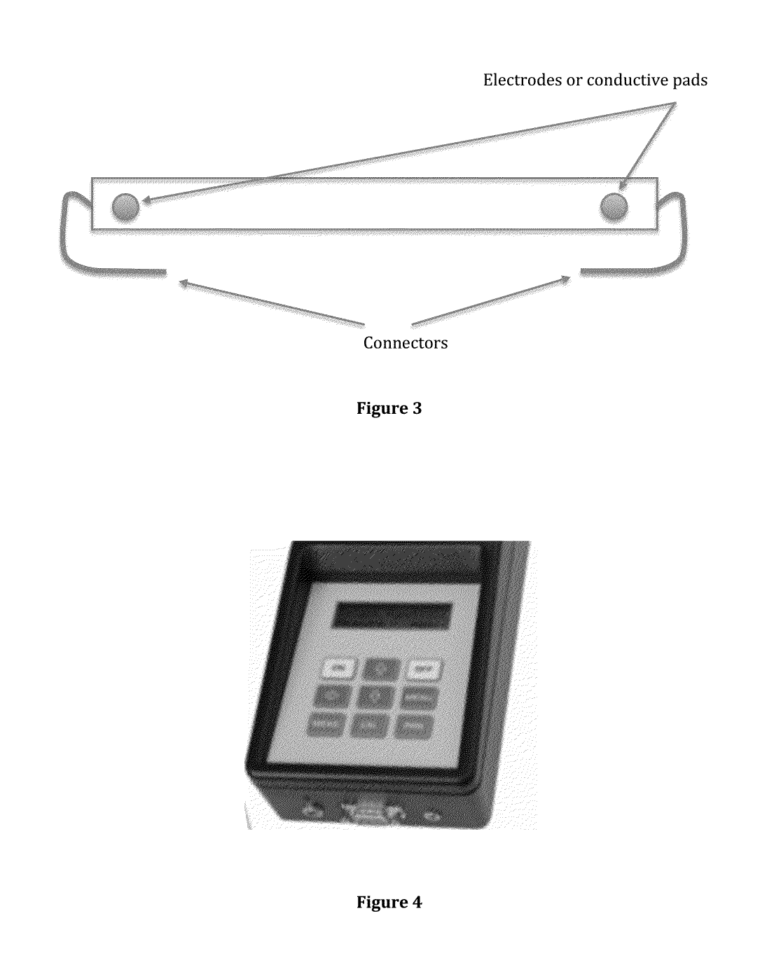

FIG. 3 shows a schematic representation of a strip with small electrodes (electric leads) that are mounted on the strip such that the strip can be attached to the body of the wrap around body of the massager. The electrical lead connectors are also shown at the two ends of the strip.

After attaching the vibrating heads and the electrodes, the bandage like wrap around is toed to the body such that the vibrators and the electrodes are in physical contact of the skin. This facilitates better massage and proper electrical stimulation. The same controller unit can control all the components.

Both the massager unit of FIG. 2 and the electro-stimulator strips of FIG. 3 can be placed on the wrap around to allow personalization of the current invention.

FIG. 4 shows a schematic diagram of a controller unit that allows programming of the vibrating motors and the electric stimulation pads. A few of the connectors are shown for use with power supply units and for controlling the vibrating motors and stimulation pads. The controller unit has an inbuilt battery housing in addition to additional USB and other connectors that are not shown in this image. The controller unit is also equipped with a Blue Tooth, remote sensor and additional connector units that are not shown in the image.

in a typical embodiment the user positions vibrating head containing strip(s) on the bandage (FIG. 1). Then the user optionally places electro stimulator units on the same strip. Then the bandage is wrapped around at the location of the injury or pain. The controller unit is suitably programmed to give the desired level of massage and electro stimulation in any possible combination.

It will be apparent to those skilled in the art that many variations to the nature, location or presentation of the combination of vibrating massager and electro-stimulation of muscles are possible within the scope of the invention.

In the foregoing specification, the invention has been described with reference to specific exemplary embodiments thereof. It will, however, be evident that various modifications and changes may be made thereunto without departing from the broader spirit and scope of the invention as set forth in the claims. The specification and drawings are accordingly to be regarded in an illustrative rather than a restrictive sense.

What is claimed is:

1. A wearable reusable massager system comprising: a singular or plurality of straps and/or wrap-around that are adaptable to retain massaging components against the body of a wearer; and a plurality of vibration heads embedded in or attached to massage a desired muscle area.

2. The wearable reusable massage unit of claim 1 further comprising of one or more units of prior art electrical muscle stimulation devices that can be detachably attached to the wrap in a user preferred configuration to provide stimulation to section(s) of the body adjacent, proximate or distant to the massage area(s) thereby creating a medically meaningful combination of muscle relaxation and stimulation resulting in maximized anatomical and physiological benefit to the user of the unit.

3. The wearable reusable massager unit of claim 2 further comprising: straps, pads, wraparounds or any wearable material that can be tied to, fitted, attached to or conforms to different sections of the body.

4. The wearable reusable massage unit of claim 2 further comprising of Velcro, loop-hook or any detachably attachable material.

5. In one embodiment the wearable reusable massager unit of claim 2 further comprising: pads that can be held in position with the help of additional fastening devices like sticky plaster or bandages of any known kind.

6. The wearable reusable massage unit of claim 2 further comprising of single or multiple units to cover selective areas of the body where massaging needs to applied.

7. The wearable reusable massager of claim 2 further comprising: an electric, USB (or similar connectors) accessible programmable controller unit coupled to the massaging units to cause the massaging components to vibrate, thereby massaging the muscles.

8. The programmable controller unit of claim 7 further comprising of programming options or other means to apply different levels of power to different massaging heads in order to create localized variation of the massage creating highly customized massage for individual users. Power to electro-stimulators is also variable allowing user specific customization.

9. The wearable reusable massager and controlling unit of claim 2 further comprising: power source of one or more replaceable battery, rechargeable battery, solar power, USB or other suitable plug in power source or any convenient commercially available power source including but not limited to contact based power supply units.

10. The wearable reusable massager and controlling unit of claim 2 further comprising: a logic chip that is programmable to allow manual control, pre-preprogrammed settings, or dynamic programming of the massage cycles to provide the best relief to the user. The massage programs might be controlled and managed through a traditional knob, switch or graphical interface.

11. The wearable reusable massager and controlling unit of claim 2 further comprising: massage programs might be controlled and managed through an attached or through remote wireless devices managed through Bluetooth or any other commonly used technologies.

12. The wearable reusable massager unit of claim 2 further comprising: a singular or plurality of heating elements, magnetic strips, gel strips that can be preheated or pre-cooled.

13. The wearable reusable massager unit in claim 2 further comprising: a multilayered wrap around whereby air or water can be pumped between two layers allowing inflation of the wrap for better and more comfortable fit on the user's body.

14. The wearable reusable massager unit in claim 2 further comprising: a multilayered wrap around whereby hot or cold air, water or other fluid can be pumped in to provide high temperature or low temperature in and around the massage area.
